(19) United States
(12) Patent Application Publication
(10) Pub. No.: US 2017/0122778 A1
(43) Pub. Date: May 4, 2017

(54) ENCODER DISKS

(71) Applicant: Hewlett-Packard Indigo B.V., Amstelveen (NL)

(72) Inventors: Lavi Cohen, Beit Shean (IL); Roy Maman, Ness Ziona (IL); Alex Feygelman, Petach-Tiqwa (IL); Asaf Shoshani, Sderot (IL)

(21) Appl. No.: 14/925,628

(22) Filed: Oct. 28, 2015

(51) Int. Cl. G01D 5/14; G01D 5/347; G01D 5/16

(52) U.S. Cl. CPC G01D 5/142; G01D 5/16; G01D 5/3473

(57) ABSTRACT

An encoder disk comprising at least a first detectable target and a second detectable target, which are straight and parallel, and a rotary encoder comprising such an encoder disk.

### BACKGROUND

Encoder disks are widely used for measuring the speed of rotating elements. In general, an encoder disk may feature a pattern, the detection of which allows for determination the rotational speed of the encoder disk.

A possible application for encoder disks is in rotary encoders. Rotary encoders are electro-mechanical devices comprising an encoder disk and a sensor to detect a pattern of the encoder disk and, thus, rotational movement of the encoder disk. An aspect with respect to encoder disks is the accuracy with which rotational movement of an encoder disk can be determined.

### BRIEF DESCRIPTION OF THE DRAWINGS

FIG. 1 illustrates an encoder disk according to an example,

FIG. 2 illustrates an encoder disk according to an example,

FIG. 3 shows a view of a part of an encoder disk according to an example,

FIG. 4 shows a view of a part of an encoder disk according to an example,

FIG. 5 illustrates an encoder disk according to one example,

FIG. 6 illustrates a rotary encoder according to one example,

FIG. 7 is a flowchart illustrating an example method of determining a rotation speed,

FIGS. 8A and 8B illustrate two example sensor signals, each recorded with a rotary encoder according to one example.

### DETAILED DESCRIPTION OF THE DRAWINGS

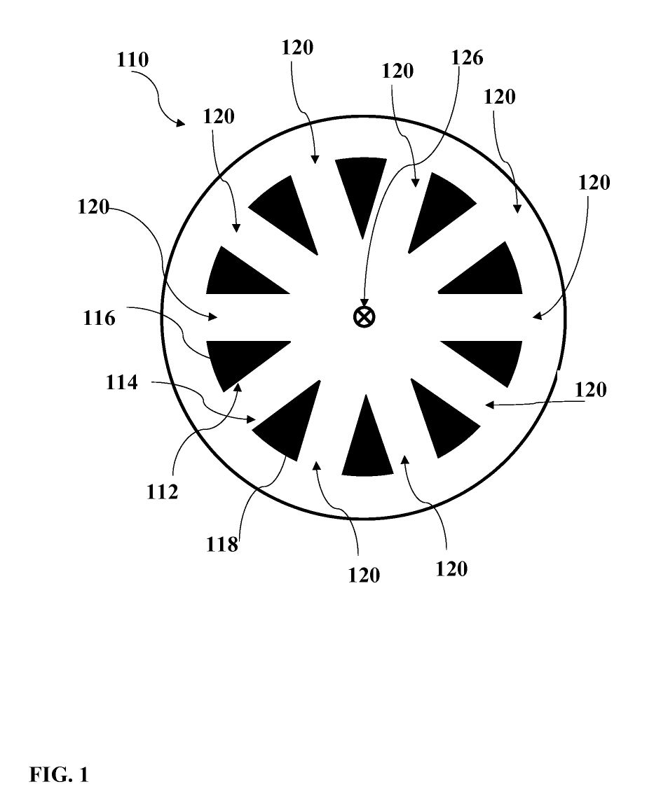

FIG. 1 schematically illustrates an encoder disk according to one example. However, before proceeding further with a detailed description of FIG. 1, further aspects are discussed.

An aspect provides an encoder disk. The encoder disk comprises at least one set of a first detectable target and a second detectable target, wherein the first detectable target and the second detectable target are straight and parallel.

The first detectable target and the second detectable target are understood to be “parallel” if the distance between them is constant and non-zero. For example, detectable targets, which are identical and/or overlapping, may be not considered as “parallel”.

Here, if not otherwise specified, the term “disk” refers to disks, toroids, rings, wheels, pinions, or the like. For instance, if the term “disk” refers to a ring, in some examples, a recess or hole may be formed in the center of the disk, e.g. for coupling with a shaft about which the disk can be rotated. Depending on the material or manufacturing or assembly, the disk may not be perfectly round but a polygon. A disk may show a certain degree or rotational symmetry around an axis. A disk may also have a rectangular shape, wherein it is contemplated that such a disk can be rotated in a plane in which the rectangular shape extends and/or about an axis extending perpendicularly through that plane.

The term “detectable target” particularly indicates that a “target” is a part of the encoder disk that can be technically detected.

A detectable target may differ in at least one property as compared with other part(s) of the encoder disk. Such a difference may reside, for example, in at least one of shape, color, optical property (e.g. reflectivity, absorbance, transparency, brightness, luminance, contrast, visible pattern, polarization etc.), electrical property (e.g. conductivity, ohmic resistance, inductivity, capacitance etc.), magnetic property (e.g. magnetization).

In such cases, a detectable target may be an object or a part of an object, for example, in the form of a structure, feature, etc. (e.g. line) which as such differs in at least one property as compared with other part(s) of the encoder disk.

A detectable target may provide a change of at least one property as compared with other part(s) of the encoder disk. Such a change may reside, for example, in at least one of a change of shape, change of color, change of optical property (e.g. reflectivity, absorbance, transparency, brightness, luminance, contrast, visible pattern, polarization etc.), change of electrical property (e.g. conductivity, ohmic resistance, inductivity, capacitance etc.), change of magnetic property (e.g. magnetization).

In such cases, a detectable target may be an interface and/or transition between objects or parts of an object, for example, in the form of a structure, feature, etc. (e.g. edge) which provides a change of at least one property as compared with other part(s) of the encoder disk.

The term “detectable target” may refer to slits, protrusions, recesses, or lines or areas of different material or material properties. Material properties include at least one of the above mentioned differences, for example optical properties, such as color, transparency, brightness, electro-magnetic properties, such as magnetization, etc.

In general, a detectable target can be detected by means of at least one sensor device. The at least one sensor device may comprises at least one of an optical sensor, an electrical sensor, a magnetic sensor, an electro-magnetic sensor.

For example, a detectable target having a difference in an optical property with respect to other part(s) of the encoder disk (e.g. a white line on black background; a white area on a black background; a black line on white background; a black area on a white background) may be detected by means of an optical sensor (e.g. reflectometer), wherein a change of a sensor signal from the sensor device (e.g., a sharp short rise in the reflection signal; a step-like rise in the reflection signal; a sharp short drop in the reflection signal; a step-like drop in the reflection signal) may indicate that the detectable target has been detected.

Changes in sensor signals include (positive or negative) spikes, step-like functions (rise or fall), gradients.

In some examples of the encoder disk, the plurality of detectable targets is arranged circumferentially to the encoder disk.

The first detectable target and the second detectable target can be associated. The term “associated” refers to the possibility of using a time difference between detection of the first detectable target and detection of the second detectable target, for example, to compute a rotational motion of the encoder disk, like its rotational speed. In particular, the first detectable target and the second detectable target may be “neighbors”, i.e. two detectable targets having no other detectable target located between them.

In some example encoder disks, the first detectable target may have a first longitudinal axis and/or the second detectable target may have a second longitudinal axis, wherein at least one of the first longitudinal axis and the second longitudinal axis do not extend through a center of the encoder disk. As used herein, the term “center” is understood to encompass any intended location for a rotational axis, about which the encoder disk may be intended to be rotated. This may include any of the following: a geometric center, a center of mass, and a center of symmetry.

The center of the encoder disk may by located between the first longitudinal axis and the second longitudinal axis.

The center of the encoder disk may by located between the first longitudinal axis and the second longitudinal axis such that the distance between the center and the first longitudinal axis and the distance between the center and the second longitudinal axis are equal.

In the case of more than one set of a first detectable target and a second detectable target, the center of the encoder disk may be equidistant to all longitudinal axes of the detectable targets.

Another aspect provides a rotary encoder. The rotary encoder comprises an encoder disk and a sensor. The encoder disk comprises at least one set of a first detectable target and a second detectable target, wherein the first detectable target and the second detectable target are straight and parallel. The sensor can detect the first detectable target and the second detectable target of the encoder disk.

The rotary encoder may comprise a processing device to obtain sensor signals from the sensor to determine rotational motion of the encoder disk.

In some examples, the rotary encoder may comprise a shaft.

In some examples, the sensor may comprise a first sensor part and second sensor part to detect the first detectable target and the second detectable target. The two sensor parts may deliver a quadrature signal. A quadrature signal may include two square waves, which are 90° out of phase. Such two sensor part type sensors can be used to detect the direction of rotation.

In some examples, the sensor may include: a photodetector, a magneto-resistive sensor, a Hall effect sensor, a polarization sensor, or the like.

In some examples, a rotational axis for the encoder disk does not extend though a geometric center and/or a center of mass of the encoder disk.

Another aspect provides a method of determining a rotational motion of an encoder disk about a rotational axis, the encoder disk comprising at least one set of a first detectable target and a second detectable target, wherein the first detectable target and the second detectable target are straight and parallel. The method comprises obtaining sensor signals, for at least one of the at least one set, indicative of the respective first detectable target and the respective second detectable target of the encoder disk, and computing the rotational motion on the basis of the obtained sensor signals.

In some examples of the method, the sensor signals may be a time series of binary signals. Computing the rotational motion may comprise computing at least one time difference(s) based on the time series of binary signals. Computing the rotational motion can be based on the computed time difference(s) and an effective radius associated with the set of a first detectable target and a second detectable target and/or the sensor.

Binary signals may be digital or analog. A detection of a detectable target may comprise a state change in the binary signal. Time difference(s) may for instance be computed between detections of detectable targets. An effective radius may for instance be defined by the distance between the rotational axis and an orientation axis of a sensor.

In some examples of the method, computing the rotational motion may comprise determining a maximum or minimum of eccentricity-based error. The term “eccentricity-based error” may refer to a deviation of the computed rotational motion from the actual rotational motion due to the erroneous assumption of perfect concentricity between the rotational axis and the encoder disk.

FIG. 1 shows an example encoder disk 110 in top view. The encoder disk 110 comprises a first set 120 of a first detectable target 112 and a second detectable target 114, wherein first detectable target 112 and the second detectable target 114 are straight and parallel.

The following remarks made with respect to the first detectable target 112 and the second detectable target 114 of the first set 120 generally apply to all further illustrated sets 120. The respective first and second detectable targets 112 and 114 of the illustrated sets 120 can be pair-wise parallel.

The first detectable target 112 is formed by an edge of a first surface area 116, which is depicted in solid black. The second detectable target 114 is formed by an edge of a second surface area 118, which is depicted in solid black. The first surface area 116 and the second surface area 118 are separated by a white surface area. No other detectable target is arranged in between the first detectable target 112 and the second detectable target 114, i.e. they are neighbors.

The sets 120 of detectable targets can be arranged circumferentially on the encoder disk 110. For example, the sets 120 of detectable target can be disposed around the circumference of the encoder disk 110.

The encoder disk 110 further comprises a center 126. In the present case, the center 126 of the encoder disk 110 corresponds to the geometric center and/or to the center of mass of the encoder disk 110, for example assuming for instance a homogenous or rotation-symmetric distribution of density of the circle-round disk. The center 126 of the encoder disk 110 may for instance be the location of a threaded hole or bore for mounting onto a rotation shaft of, for example, a rotatable element. The encoder disk 110 may thus be used for determining a rotational motion and, particularly, a rotation speed of the rotatable element.

Upon rotation the encoder disk 110, the motion of the sets 120 of detectable targets is characteristic of the rotational motion of the encoder disk 110. For instance, a sensor can sense detectable targets of the encoder disk 110 may be placed in proximity and directed towards the detectable targets. The sensor may be chosen in dependence of the properties of the first detectable target 112 and the second detectable target 114. In the present case, the first surface area 116 and the second surface area 118 may show a relatively low reflectance of visible wavelength light, compared a relatively high reflectance of the white surface area in between. Accordingly, a reflectance sensor may be chosen for sensing detectable targets of the encoder disk 110 of FIG. 1. The detectable targets appear as a step-like rise or a step-like fall of reflectance signal. The sensor generates sensor signal each time a detectable target 112 and/or 114 passes. Various details of the present disclosure are described in reference to an example rotary encoder below.

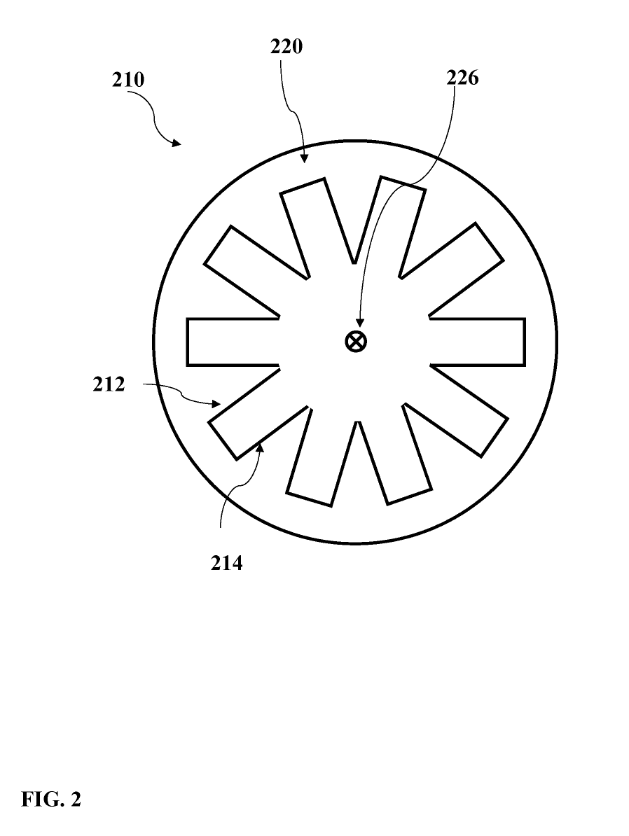

FIG. 2 illustrates an encoder disk 210 according to another example. The example encoder disk 210 of FIG. 2 is in many respects similar to the example encoder disk 110 of FIG. 1, similar elements being referenced by the similar reference numeral.

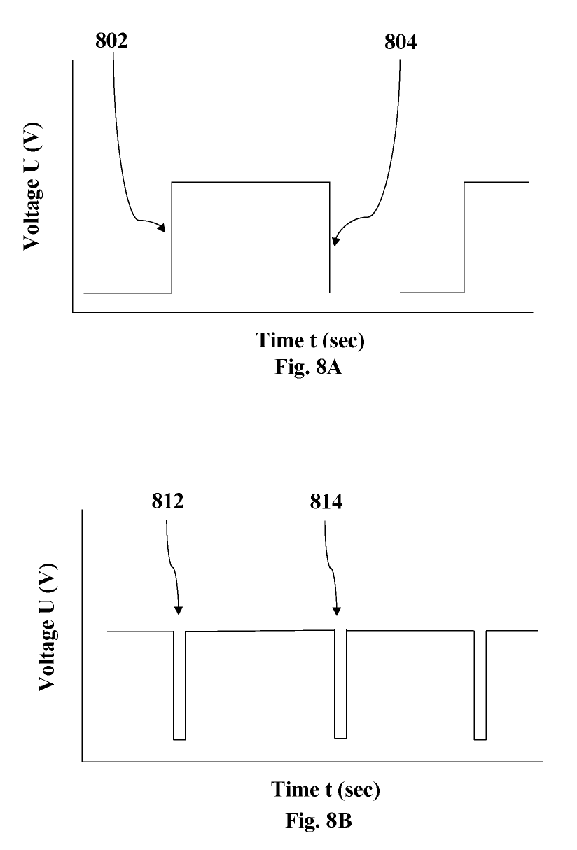

However, in FIG. 2, the sets 220 of detectable targets, in particular the first detectable target 212 and the second detectable target 214, are formed by black lines, rather than by edges between black and white surface areas. As a result, a suitable sensor can sense the detectable targets as a short spike (in positive or negative direction), rather than a persistent step-like rise or fall. These alternatives are depicted in FIG. 8, which illustrates two example sensor signals. The example sensor signal of FIG. 8A may for instance be recorded upon rotation of the example encoder disk 110 of FIG. 1, wherein the example sensor signal of FIG. 8B may for instance be recorded upon rotation of the example encoder disk 210 of FIG. 2.

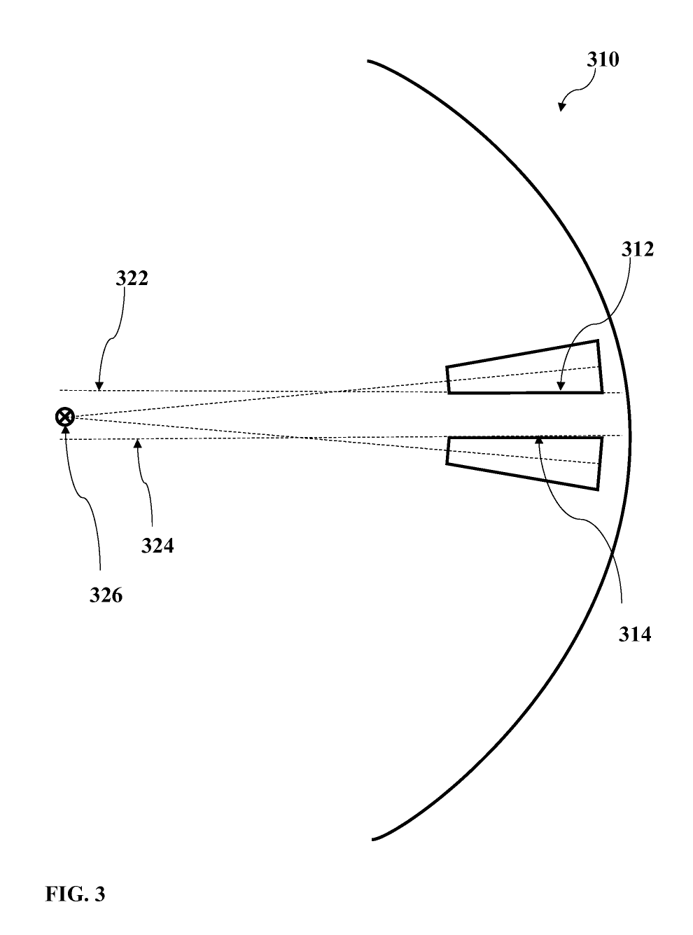

FIG. 3 shows a view of a part of an encoder disk 310 according to another example. The encoder disk 310 comprises a first detectable target 312 and a second detectable target 314, which are straight and parallel. The latter is made apparent for illustration purposes by a first dashed line indicating a first longitudinal axis 322 of the first detectable target 312 and a second dashed line indicating a second longitudinal axis 324 of the second detectable target 314. The first longitudinal axis 322 and the second longitudinal axis 324 do not extend through the center 326 of the encoder disk 310. In particular, the center 326 of the encoder disk 310 is situated equidistantly between the first longitudinal axis 322 and the second longitudinal axis 324.

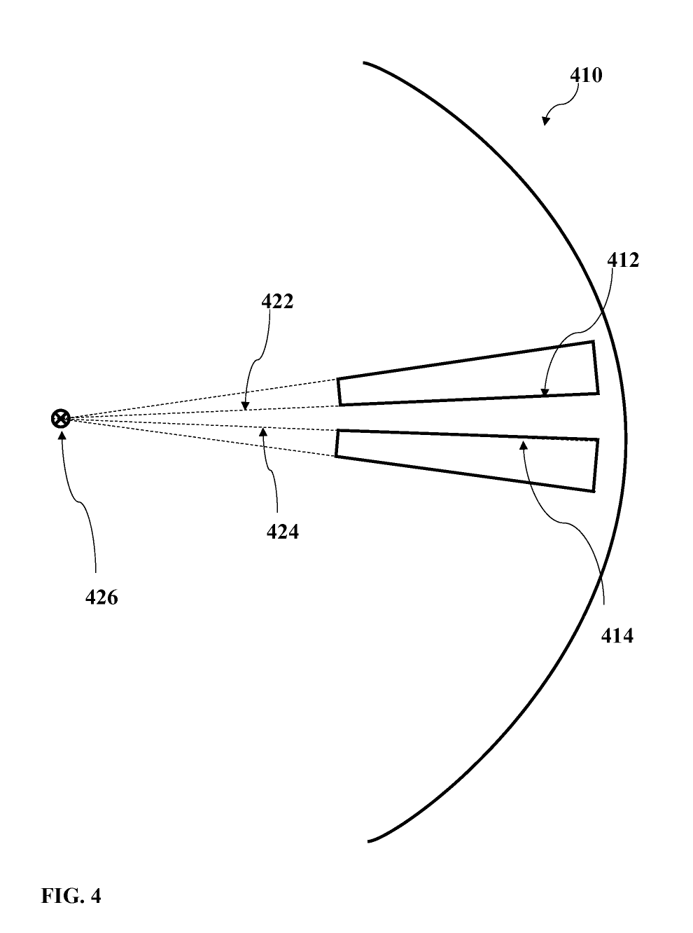

The arrangement of FIG. 3 is in contrast to an arrangement illustrated in FIG. 4. FIG. 4 shows a view of a part of an encoder disk 410, which may also comprise a first detectable target 412 and a second detectable target 414. The first detectable target 412 may have a first longitudinal axis 422. The second detectable target 414 may have a second longitudinal axis 424. However, the first longitudinal axis 422 and the second longitudinal axis 424 are not parallel and, thus, intersect. As illustrated, the point of intersection is the center 426 of the encoder disk 410.

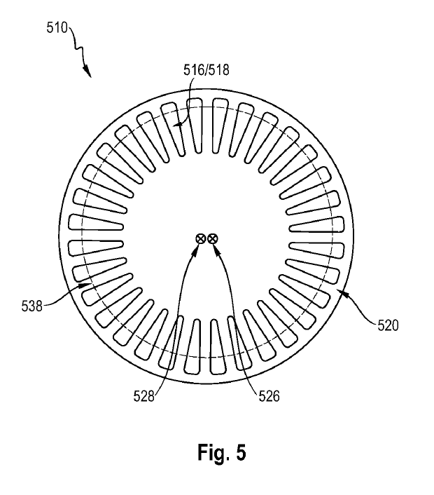

FIG. 5 illustrates an example encoder disk 510. The encoder disk 510 comprises sets 520 of detectable targets, which are straight and pair-wise parallel. The sets 520 of detectable targets are arranged circumferentially on the encoder disk 510. In the present case, each one detectable targets of the sets 520 of is formed by the lateral edge of one of a plurality of wedges 516/518. A wedge may include a magnetized material, in contrast to non-magnetized inter-wedge areas. Such detectable targets, formed as an edge between differently-magnetized materials, may be sensed by a sensor sensitive to magnetic properties, such as a magneto-resistive sensor or a Hall Effect sensor. A sensor signal generated by a magneto-resistive sensor and indicative of a detectable target may comprise a change in resistance. A sensor signal generated by a Hall Effect sensor and indicative of a detectable target may comprise a change in voltage.

The encoder disk 510 of FIG. 5 may be rotated around a rotational axis, e.g. as part of a rotary encoder. The rotational axis 528 of the encoder disk 510 may not coincide with a geometric center 526 and/or a center of mass 526 of the encoder disk 510. As a result, a sensor to detect detectable targets of the encoder disk 510 may operate along an eccentric circle 538 with respect to the rotational axis 528 (as a projection in the reference frame of the encoder disk 510). The measurement path of the sensor along the eccentric circle 538 is depicted in FIG. 5 for illustrative purposes. Elements located on positions covered by the eccentric circle 538 are rotating at the same speed. However, the sensor determines a length between detectable targets, which varies with the eccentricity and the location around the circumference of the encoder disk.

When the encoder disk of FIG. 5 is used for a determination of a rotational motion, the error due to eccentricity can be estimated on the basis of the sensor location. If the sensor is located above the left-hand apex or right-hand apex in FIG. 5, then no error due to eccentricity is incurred: Since the detectable targets are pair-wise parallel, a mere lateral shift does not alter the distance between them. This is in contrast to alternative arrangements, such as the one depicted in FIG. 4, where the detectable targets are not parallel and thus a lateral shift alters their distance (as sensed by the sensor) and thus the determined speed. If the sensor is located above the upper-side apex or the lower-side apex in FIG. 5, then the eccentricity-based error is due to a slight inclination of the sensor-described circle 538 with respect to the straight and parallel detectable targets. The sensor-described circle overestimates the distance between detectable targets of one pair, wherein the error scales in first order approximation as the square of the eccentricity, i.e. the distance between the rotational axis 528 and the center 526 of the encoder disk 510.

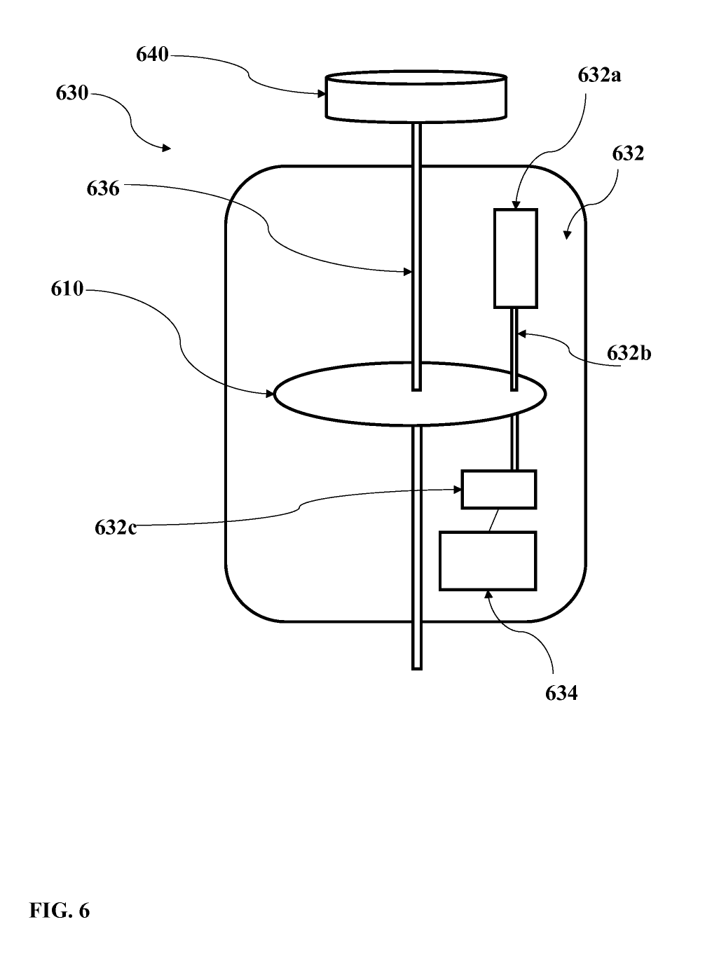

FIG. 6 illustrates a rotary encoder 630 according to one example. The rotary encoder 630 comprises an encoder disk 610, a sensor 632, a processing device 634, and a shaft 636. It may be used to determine a rotation speed of a rotatable element 640, not included in the rotary encoder 630 and coupled to the encoder disk 610 via the shaft 636.

The encoder disk 610 comprises at least a first detectable target and a second detectable target (not shown), which are straight and parallel. For instance, the first detectable target and second detectable target may be sensed by the sensor due to their properties. In the present case, the first detectable target and the second detectable target may be sensed due to their properties in transmitting light. The first detectable target and the second detectable target may be formed as edges of transparent surface areas in an otherwise opaque encoder disk 610.

The sensor 632 can sense detectable targets of the encoder disk 610. In the present case, the sensor can generate sensor signals indicative of a degree of transmission of light through the encoder disk 610. In particular, the sensor comprises a light-emitting diode 632a on one side of and directed towards the encoder disk 610 for generation and emission of light, e.g. a beam 632b. Furthermore, the sensor 632 comprises a photodetector 632c on the other side of the encoder disk 610 and directed towards the encoder disk 610, the light-emitting diode 632a, and/or light beam 632b. The photodetector 632c detects any light emitted by the light-emitting diode 632a and transmitted through the encoder disk 610.

The processing device 634 can obtain sensor signals from the sensor 632. The sensor signals upon rotation of the shaft 636 and the encoder disk 610 may for instance be similar to the one depicted in FIG. 8A. A transparent window in the encoder disk 610 translates into a sensor signal indicative of high transmission, e.g. a high sensor signal, whereas opaque portions of the encoder disk 610 translate into a sensor signal indicative of low transmission, e.g. a low sensor signal. The sensor signals may thus be binary. Transitions from transparent to opaque surfaces areas (or vice versa) are sensed as a step-like fall (or rise) in sensor signal. A detectable target formed by the edge between a transparent surface area and an opaque surface area is thus sensed as a step-like fall or rise.

The processing device 636 may further compute a rotation speed of the encoder disk 610. In particular, the processing device 636 may compute at least one time difference(s) between detection of detectable targets based on the obtained sensor signals and to compute the speed based on the time difference(s) and an effective radius. The effective radius may be defined by the distance between a rotational axis and an orientation axis of the sensor 632.

Rotary encoders such as rotary encoder 630 may be assembled easily and in great numbers. In particular, due to the reduction of the eccentricity-based error, relatively large eccentricities of the rotary encoder disk 610 during assembly of the rotary encoders 630 may still be acceptable for relatively accurate measurement of the rotation speed by the rotary encoders 630.

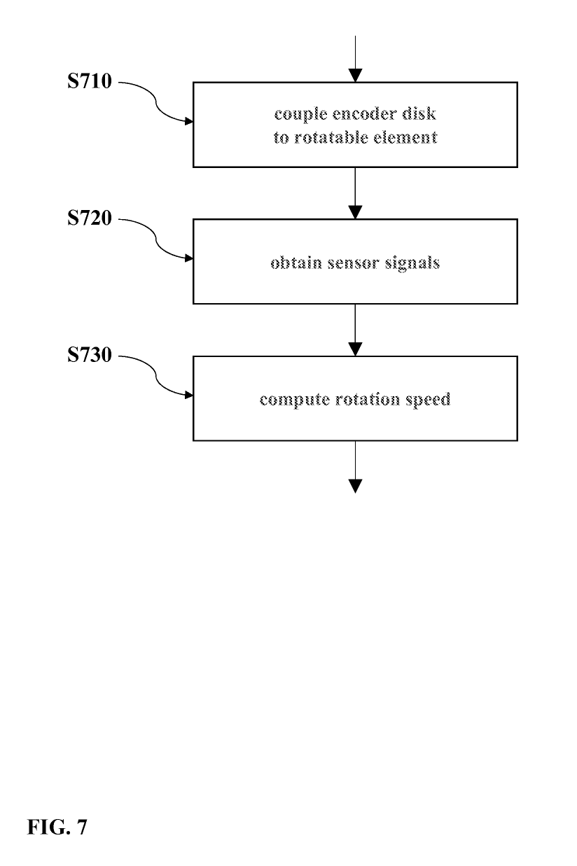

FIG. 7 is a flowchart illustrating an example method of determining a rotation speed of a rotatable element around a rotational axis. The method comprises coupling an encoder disk to the rotatable element (S710). The encoder disk comprises at least a first detectable target and a second detectable target that are straight and parallel. Furthermore, the method comprises obtaining sensor signals indicative of detectable targets of the encoder disk (S720). Furthermore, the method comprises computing the rotation speed on the basis of the obtained sensor signals (S730).

FIGS. 8A and 8B illustrate two example sensor signals, each recorded with a rotary encoder as a time trace of voltage signals. The trace of FIG. 8A may have been recorded with a rotary encoder comprising an encoder disk similar to the example of FIG. 1. In particular, the first detectable target and the second detectable target may be formed as edges of a first surface area and a second surface area, respectively. The first surface area and the second surface area may show low reflectance (e.g. a solid black colored surface). A reflectance sensor may thus generate the sensor signals of FIG. 8A. The step-like rise in reflectance signal designated by reference numeral 802 is indicative of the first detectable target of the encoder disk. The step-like fall in reflectance signal designated by reference numeral 804 is indicative of the second detectable target of the encoder disk. The time difference between the step-like rise 802 and step-like fall 804 is inversely proportional to the rotation speed of the encoder disk, wherein the proportionality factor is given by an effective radius, defined by the distance between the rotational axis and the location of the sensor.

Alternatively, in FIG. 8B, an encoder disk may be similar to the example of FIG. 2, wherein the first detectable target and the second detectable target may be formed as lines, rather than by edges between surface areas. As a result, a suitable sensor can sense the detectable targets as a short spike (in positive or negative direction), rather than a persistent step-like rise or fall. The first detectable target and the second detectable target may show low reflectance (e.g. a solid black line). A reflectance sensor may thus generate the sensor signals of FIG. 8B. The spike-like drop in reflectance signal designated by reference numeral 812 is indicative of the first detectable target of the encoder disk. The spike-like drop in reflectance signal designated by reference numeral 814 is indicative of the second detectable target of the encoder disk. The time difference between the spike-like drop 812 and spike-like drop 814 is inversely proportional to the rotation speed of the encoder disk, wherein the proportionality factor is given by an effective radius, defined by the distance between the rotational axis and the location of the sensor.

1. An encoder disk, comprising at least one set of a first detectable target and a second detectable target, wherein the first detectable target and the second detectable target are straight and parallel.

2. An encoder disk according to claim 1, comprising a plurality of target sets, each of which comprise a first detectable target and a second detectable target, wherein the first detectable target and the second detectable target of each of the plurality of target sets are pair-wise parallel.

3. An encoder disk according to the claim 1, wherein the at least one set is arranged circumferentially to the encoder disk.

4. An encoder disk according to claim 1, wherein the first detectable target and second detectable target are at least one of associated and neighbors.

5. An encoder disk according to claim 1, wherein the first detectable target has a first longitudinal axis and/or the second detectable target has a second longitudinal axis, wherein at least one of the first longitudinal axis and the second longitudinal axis do not extend through a center of the encoder disk, about which the encoder disk may be rotated.

6. An encoder disk according to the claim 1, wherein
the first detectable target has a first longitudinal axis or the second detectable target has a second longitudinal axis, wherein at least one of the first longitudinal axis and the second longitudinal axis do not extend through a center of the encoder disk, about which the encoder disk may be rotated, and
the center of the encoder disk is at least one of
located between the first longitudinal axis and the second longitudinal axis,
located between the first longitudinal axis and the second longitudinal axis such that the distance between the center and the first longitudinal axis and the distance between the center and the second longitudinal axis are equal, and
equidistant to all longitudinal axes of the detectable targets.

7. A rotary encoder, comprising
an encoder disk comprising at least one set of a first detectable target and a second detectable target, wherein the first detectable target and the second detectable target are straight and parallel;
a sensor to detect the first detectable target and the second detectable target of the encoder disk.

8. A rotary encoder according to claim 7, further comprising a processing device to process sensor signals from the sensor to determine rotational motion of the encoder disk.

9. A rotary encoder according to claim 7, wherein the sensor is one of the following: a photodetector, a magneto-resistive sensor, a Hall effect sensor.

10. A rotary encoder according to claim 7, wherein a rotation axis for the encoder disk does not extend though a geometric center and/or a center of mass of the encoder disk.

11. A method of determining a rotational motion of an encoder disk about a rotational axis, the encoder disk comprising at least one set of a first detectable target and a second detectable target, wherein the first detectable target and the second detectable target are straight and parallel, the method comprising
obtaining sensor signals, for at least one of the at least one set, indicative of the respective first detectable target and the respective second detectable target of the encoder disk,
computing the rotational motion on the basis of the obtained sensor signals.

12. A method according to claim 11, wherein
the sensor signals are a time series of binary signals, and
computing the rotational motion comprises: computing at least one time difference(s) based on the time series of binary signals and computing the speed based on the time difference(s) and an effective radius.

13. A method according to claim 11, wherein computing the rotational motion comprises determining a maximum or minimum of eccentricity-based error.
